(19) United States
(12) Patent Application Publication
(10) Pub. No.: US 2025/0360881 A1
(43) Pub. Date: Nov. 27, 2025

(54) TRUCK RACK SYSTEM

(71) Applicant: Thule Sweden AB, Hillerstorp (SE)

(72) Inventors: Peter WIKSTRÖM, Skillingaryd (SE); Markus NORDANGÅRD, Värnamo (SE); Emil ANDERSSON, Jönköping (SE)

(21) Appl. No.: 19/193,286

(22) Filed: Apr. 29, 2025

Related U.S. Application Data
(60) Provisional application No. 63/651,587, filed on May 24, 2024.

(51) Int. Cl. B60R 9/06

(52) U.S. Cl. CPC B60R 9/06

(57) ABSTRACT

A vehicle rack system for adjustably attaching equipment to a vehicle can include a base, an upper saddle, and a telescoping upright. The base can be configured to be removably coupled to the vehicle. The upper saddle can be spaced apart from the base and coupled to a cross-rail. The telescoping upright can extend from the base to the upper saddle. The telescoping upright can include a first arm, a telescoping arm, and a locking system. The telescoping arm can be slideably disposed within the first arm. The locking system can be configured to releasably couple the first arm and the telescoping arm. When the locking system is actuated, the telescoping arm can slide relative to the first arm to adjust a distance between the cross-rail and the base.

### BACKGROUND

### Field

The present disclosure relates to equipment for vehicles, such as pickup trucks. More specifically, embodiments of the present disclosure relate to a releasably attachable and height-adjustable rack system for attaching to a truck bed.

### Background

Vehicle racks and systems can connect to various parts of a vehicle such as a cab and side walls of a truck bed. Some rack systems that connect to a truck bed have a frame-like structure that includes a connection for attaching the rack to a vehicle as well as a structure for receiving accessories for customizing the rack system. For example, some rack systems include a base or footing, a vertical tube or post, a cross-rail, and fasteners for connecting these components together. These rack systems can have cumbersome attaching and adjusting features making it difficult for a user to quickly and easily install and adjust them without support.

### BRIEF SUMMARY

Accordingly, there is a need to provide a truck rack system that is easy to use, mount, and adjust with a single user.

In some embodiments, a vehicle rack system, for adjustably attaching equipment to a vehicle, includes a base, an upright, and a telescoping upright. In some embodiments, the base can be configured to removably couple to the vehicle. In some embodiments, the upper saddle can be spaced apart from the base and coupled to a cross-rail. In some embodiments, the telescoping upright can extend from the base to the upper saddle. In some embodiments, the telescoping upright can include a first arm, a telescoping arm, and a locking system. In some embodiments, the telescoping arm can be slideably disposed within the first arm. In some embodiments, the locking system can be configured to releasably couple the first arm and the telescoping arm. In some embodiments, when the locking system is actuated, the telescoping arm can slide relative to the first arm to adjust a distance between the cross-rail and the base. In some embodiments, the telescoping arm can include a slot and a plurality of locking notches. In some embodiments, the locking system can include a lock plate disposed within the slot and configured to releasably engage the plurality of locking notches to lock the telescoping arm relative to the first arm. In some embodiments, the lock plate can include at least two protrusions configured to engage at least two notches of the plurality of locking notches. In some embodiments, the lock plate can be biased towards the plurality of locking notches.

In some embodiments, the locking system can include an actuator adjustably coupled to the lock plate and can extend through an aperture in the first arm. In some embodiments, the actuator can be configured to adjust the locking system between a locked configuration and a released configuration. In some embodiments, in the locked configuration, the actuator can hold the lock plate in engagement with the plurality of locking notches such that the telescoping arm is fixed relative to the first arm.

In some embodiments, in the released configuration, the lock plate can be displaced within in the slot such that when the telescoping arm is moved in a first direction relative to the first arm, the lock plate disengages from the plurality of locking notches. In some embodiments, when the telescoping arm is moved in a second direction opposite the first direction, the lock plate engages the plurality of locking notches to fix the telescoping arm relative to the first arm. In some embodiments, the locking system can further include a bracket coupled to the first arm and extending around the actuator. In some embodiments, the bracket can be configured to reduce rotation of the actuator and allow translation of the actuator.

In some embodiments, a method of adjusting a height of a vehicle rack system can includes the steps of actuating a locking system of the upright to move the locking system from a locked configuration to a released configuration; and moving a telescoping arm of the upright relative to a first arm of the upright in a first direction to adjust the height of the cross-rail relative to the base. In some embodiments, the vehicle rack system can include a base, an upright, and a cross-rail spaced apart from the base by the upright. In some embodiments, the locking system can be configured to temporarily prevent movement of the upright in a second direction opposite the first direction when the locking system is in the released configuration.

In some embodiments, actuating the locking system can include rotating an actuator of the locking system in a first revolving direction. In some embodiments, moving the upright can include sliding the telescoping arm relative to the first arm. In some embodiments, the telescoping arm can couple to the cross-rail and the first arm can couple to the base. In some embodiments, the locking system can couple to the first arm and releasably coupled to the telescoping arm.

In some embodiments, the method can include the steps of further actuating the locking system to disengage a lock plate of the locking system from the telescoping arm; and moving the telescoping arm in the second direction to adjust the height of the cross-rail relative to the base. In some embodiments, further actuating the locking system can include translating an actuator of the locking system relative to the upright to disengage the lock plate from at least one locking notch of a plurality of locking notches formed in the telescoping arm.

In some embodiments, the method can include the steps of setting a height of the cross-rail relative to the base by moving the telescoping arm in one of the first direction or the second direction; and rotating the actuator in a second revolving direction opposite the first revolving direction to move the locking system from the released configuration to the locked configuration to fix the telescoping arm relative to the first arm.

In some embodiments, a vehicle rack system for a vehicle can include a base and a clamp member. In some embodiments, the base can be configured to be removably coupled to the vehicle. In some embodiments, the base can include a top plate and a wedge wall. In some embodiments, the top plate can be configured to be disposed on an upper portion of a sidewall of the vehicle. In some embodiments, the wedge wall can extend from the top plate adjacent to the sidewall. In some embodiments, the wedge wall can include a first wall and a second wall spaced apart from the first wall and extend at an oblique angle relative to the first wall. In some embodiments, the clamp member can be configured to couple with a rail of the vehicle to couple the base to the vehicle.

In some embodiments, the wedge wall can include a first thickness between the first and second walls at a proximal end of the wedge wall and a second thickness between the first and second walls at a distal end of the wedge wall. In some embodiments, the second thickness can be greater than the first thickness. In some embodiments, the first wall is approximately parallel to the sidewall of the vehicle. In some embodiments, the second wall can be disposed at an oblique angle relative to the sidewall of the vehicle.

In some embodiments, when the clamp member is coupled to the rail, the wedge wall can restrain the base from lifting away from the sidewall of the vehicle. In some embodiments, the clamp member can extend through a slot formed in the wedge wall. In some embodiments, the clamp member can include a bolt, a domed washer, and a coupling plate.

In some embodiments, a vehicle rack system for a vehicle can include a base and a clamp member. In some embodiments, the base can be configured to be removably coupled to a sidewall of the vehicle. In some embodiments, the base can include a top plate and a wall extending approximately perpendicular to the top plate. In some embodiments, the wall can include a first guiding surface and a second guiding surface disposed in an interior space formed through the wall. In some embodiments, the clamp member can be configured to couple the base with the sidewall of the vehicle. In some embodiments, clamp member can be configured to be supported by the first and second guiding surfaces.

In some embodiments, the first guiding surface can be opposite the second guiding surface. In some embodiments, the wall can include an inner wall member adjacent to the sidewall of the vehicle. In some embodiments, an elongated aperture can be formed through the inner wall member such that the clamp member can be configured to be adjustably moved within the elongated aperture. In some embodiments, a bolt can extend through a slot formed in the top plate and into the interior space of the wall. In some embodiments, the bolt can couple with the clamp member.

In some embodiments, the clamp member is u-shaped and wherein the sidewall of the vehicle is clamped between the clamp member and the top plate. In some embodiments, the clamp member can be configured to couple with a rail of the vehicle.

In some embodiments, the clamp member can include a hook and an adjustable contact member slideably coupled to the hook. In some embodiments, the adjustable contact member can be configured to reduce movement between the base and the sidewall of the vehicle. In some embodiments, the adjustable contact member is biased towards the wall.

In some embodiments, a first tower of a vehicle rack system for a vehicle can include a base, an upright, and an accessory upright. In some embodiments, the base can be configured to be removably coupled to the vehicle. In some embodiments, the upright can extend from the base. In some embodiments, the accessory upright can couple to the upright and the base. In some embodiments, the accessory upright can be configured to couple with a plurality of rack system accessories.

In some embodiments, the accessory upright can be disposed at an oblique angle relative to the upright. In some embodiments, the accessory upright can include at least two coupling members along a length of the accessory upright. In some embodiments, the at least two coupling member can be disposed on a side of the accessory upright facing a bed of the vehicle.

In some embodiments, a second tower can be spaced apart from the first tower. In some embodiments, the second tower can include an accessory upright. In some embodiments, at least one accessory of the plurality of rack system accessories can couple with and extend from the accessory upright of the first tower to the accessory upright of the second tower. In some embodiments, the plurality of rack system accessories can include a telescoping panel accessory. In some embodiments, the telescoping panel accessory can include a first panel slideably coupled to a second panel.

In some embodiments, the plurality of rack system accessories can include a telescoping rail accessory. In some embodiments, the telescoping rail accessory can include an inner rail slideably coupled to an outer rail. In some embodiments, an accessory plate can couple to the telescoping rail accessory. In some embodiments, the accessory plate can couple to the inner rail. In some embodiments, the accessory plate can include an accessory slot. In some embodiments, the accessory slot can align with an outer rail slot extending through the outer rail. In some embodiments, the upright, the accessory upright, and the base can form a triangular structure.

In some embodiments, an accessory rail for a vehicle rack system can include an outer rail, an inner rail, and an accessory plate. In some embodiments, the inner rail can be slideably disposed in the outer rail. In some embodiments, the accessory plate can couple to a first side of the inner rail.

In some embodiments, the accessory plate can be disposed only on the first side of the inner rail. In some embodiments, the accessory plate can include an accessory slot. In some embodiments, the accessory slot can align with an outer rail slot extending along the outer rail. In some embodiments, the inner rail can include a recess formed along a length of the inner rail. In some embodiments, the accessory plate can extend into the recess of the inner rail.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a vehicle rack system coupled to a vehicle, according to an embodiment.

FIG. 2A illustrates a front view of a vehicle rack system disposed at a first height, according to an embodiment.

FIG. 2B illustrates a front view of the vehicle rack system of FIG. 2A disposed at a second height, according to an embodiment.

FIG. 3A illustrates an outer perspective view of a tower of a vehicle rack system, according to an embodiment.

FIG. 3B illustrates an inner perspective view of the tower of FIG. 3A, according to an embodiment.

FIG. 4 illustrates a detailed perspective view of an upright and locking system of a vehicle rack system, according to an embodiment.

FIG. 5 illustrates an exploded perspective view of a locking system for an upright of a vehicle rack system, according to an embodiment.

FIG. 6 illustrates a cutaway perspective view of an upright and a locking system of a vehicle rack system, according to an embodiment.

FIG. 7A illustrates a cross-sectional front view of an upright and a locking system of a vehicle rack system in a locked configuration, according to an embodiment.

FIG. 7B illustrates a cross-sectional front view of an upright and a locking system of a vehicle rack system in a released configuration, according to an embodiment.

FIG. 8 illustrates a front view of a base and clamp member of a vehicle rack system, according to an embodiment.

FIG. 9 illustrates a cross-sectional front view of a base and clamp member of a vehicle rack system, according to an embodiment.

FIG. 10 illustrates a cross-sectional view of a clamp member, according to an embodiment.

FIG. 11A illustrates the clamp member of FIG. 10 in a first position, according to an embodiment.

FIG. 11B illustrates the clamp member of FIG. 10 in a second position, according to an embodiment.

FIG. 12 illustrates a cutaway top view of a base of a vehicle rack system, according to an embodiment.

FIG. 13 illustrates a side view of a base of a vehicle rack system, according to an embodiment.

FIG. 14 illustrates a perspective view of a base coupled to a rail of a vehicle, according to an embodiment.

FIG. 15 illustrates a cross-sectional front view of the base of FIG. 14, according to an embodiment.

FIG. 16 illustrates a cross-sectional front view of a base and clamp member of a vehicle rack system, according to an embodiment.

FIG. 17 illustrates a side view of a vehicle rack system with accessory rails, according to an embodiment.

FIG. 18 illustrates a perspective view of a vehicle rack system with accessory panels, according to an embodiment.

FIG. 19 illustrates a perspective view of a vehicle rack system with accessory rails, according to an embodiment.

FIG. 20 illustrates a detailed perspective view of an accessory plate coupled to an accessory rail, according to an embodiment.

FIG. 21 illustrates a cross-sectional front view of the accessory plate of FIG. 20, according to an embodiment.

FIG. 22 illustrates an inner perspective view of a tower of a vehicle rack system, according to an embodiment.

FIG. 23 illustrates a bicycle rack accessory coupled to a vehicle rack system, according to an embodiment.

FIG. 24 illustrates a detailed perspective view of an upright saddle coupled to a cross-rail of a vehicle rack system, according to an embodiment.

FIG. 25 illustrates a cross-sectional side view of an upright saddle coupled to a cross-rail of a vehicle rack system, according to an embodiment.

FIG. 26 illustrates an exploded front view of an upright saddle and a cross-rail assembly of a vehicle rack system, according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Embodiment 1 of the description—A vehicle rack system for adjustably attaching equipment to a vehicle, the vehicle rack system includes a base configured to be removably coupled to the vehicle; an upper saddle spaced apart from the base and coupled to a cross-rail; and a telescoping upright extending from the base to the upper saddle, wherein the telescoping upright includes a first arm, a telescoping arm slideably disposed within the first arm, and a locking system configured to releasably couple the first arm and the telescoping arm, wherein when the locking system is actuated, the telescoping arm slides relative to the first arm to adjust a distance between the cross-rail and the base.

Embodiment 2 of the description—The vehicle rack system of embodiment 1, wherein the telescoping arm includes a slot and a plurality of locking notches, and wherein the locking system includes a lock plate disposed within the slot and configured to releasably engage the plurality of locking notches to lock the telescoping arm relative to the first arm.

Embodiment 3 of the description—The vehicle rack system of embodiment 2, wherein the lock plate includes at least two protrusions configured to engage at least two notches of the plurality of locking notches.

Embodiment 4 of the description—The vehicle rack system of embodiment 2, wherein the lock plate is biased towards the plurality of locking notches.

Embodiment 5 of the description—The vehicle rack system of embodiment 2, wherein the locking system includes an actuator adjustably coupled to the lock plate and extending through an aperture in the first arm, wherein the actuator is configured to adjust the locking system between a locked configuration and a released configuration.

Embodiment 6 of the description—The vehicle rack system of embodiment 5, wherein in the locked configuration, the actuator holds the lock plate in engagement with the plurality of locking notches such that the telescoping arm is fixed relative to the first arm.

Embodiment 7 of the description—The vehicle rack system of embodiment 5, wherein in the released configuration, the lock plate is displaced within in the slot such that when the telescoping arm is moved in a first direction relative to the first arm, the lock plate disengages from the plurality of locking notches, and when the telescoping arm is moved in a second direction opposite the first direction, the lock plate engages the plurality of locking notches to fix the telescoping arm relative to the first arm.

Embodiment 8 of the description—The vehicle rack system of embodiment 5, further includes a bracket coupled to the first arm and extending around the actuator, wherein the bracket is configured to reduce rotation of the actuator and allow translation of the actuator.

Embodiment 9 of the description—A method of adjusting a height of a vehicle rack system, wherein the vehicle rack system includes a base, an upright, and a cross-rail spaced apart from the base by the upright, the method includes the steps of actuating a locking system of the upright to move the locking system from a locked configuration to a released configuration; and moving a telescoping arm of the upright relative to a first arm of the upright in a first direction to adjust the height of the cross-rail relative to the base, wherein the locking system is configured to temporarily prevent movement of the upright in a second direction opposite the first direction when the locking system is in the released configuration.

Embodiment 10 of the description—The method of embodiment 9, wherein actuating the locking system includes rotating an actuator of the locking system in a first revolving direction.

Embodiment 11 of the description—The method of embodiment 9, wherein moving the upright includes sliding the telescoping arm relative to the first arm.

Embodiment 12 of the description—The method of embodiment 11, wherein the telescoping arm is coupled to the cross-rail and the first arm is coupled to the base.

Embodiment 13 of the description—The method of embodiment 11, wherein the locking system is coupled to the first arm and releasably coupled to the telescoping arm.

Embodiment 14 of the description—The method of embodiment 10, further including the steps of further actuating the locking system to disengage a lock plate of the locking system from the telescoping arm; and moving the telescoping arm in the second direction to adjust the height of the cross-rail relative to the base.

Embodiment 15 of the description—The method of embodiment 14, wherein further actuating the locking system includes translating an actuator of the locking system relative to the upright to disengage the lock plate from at least one locking notch of a plurality of locking notches formed in the telescoping arm.

Embodiment 16 of the description—The method of embodiment 15, further including the steps of setting a height of the cross-rail relative to the base by moving the telescoping arm in one of the first direction or the second direction; and rotating the actuator in a second revolving direction opposite the first revolving direction to move the locking system from the released configuration to the locked configuration to fix the telescoping arm relative to the first arm.

Embodiment 17 of the description—A vehicle rack system for a vehicle includes a base configured to be removably coupled to the vehicle, wherein the base includes a top plate configured to be disposed on an upper portion of a sidewall of the vehicle, and a wedge wall extending from the top plate adjacent to the sidewall, wherein the wedge wall includes a first wall and a second wall spaced apart from the first wall and extending at an oblique angle relative to the first wall; and a clamp member configured to couple with a rail of the vehicle to couple the base to the vehicle.

Embodiment 18 of the description—The vehicle rack system of embodiment 17, wherein the wedge wall includes a first thickness between the first and second walls at a proximal end of the wedge wall and a second thickness between the first and second walls at a distal end of the wedge wall, wherein the second thickness is greater than the first thickness.

Embodiment 19 of the description—The vehicle rack system of embodiment 17, wherein the first wall is approximately parallel to the sidewall of the vehicle, and the second wall is disposed at an oblique angle relative to the sidewall of the vehicle.

Embodiment 20 of the description—The vehicle rack system of embodiment 17, wherein when the clamp member is coupled to the rail, the wedge wall restrains the base from lifting away from the sidewall of the vehicle.

Embodiment 21 of the description—The vehicle rack system of embodiment 17, wherein the clamp member extends through a slot formed in the wedge wall.

Embodiment 22 of the description—The vehicle rack system of embodiment 17, wherein the clamp member includes a bolt, a domed washer, and a coupling plate.

Embodiment 23 of the description—A vehicle rack system for a vehicle includes a base configured to be removably coupled to a sidewall of the vehicle, wherein the base includes a top plate and a wall extending approximately perpendicular to the top plate, wherein the wall includes a first guiding surface and a second guiding surface disposed in an interior space formed through the wall; and a clamp member configured to couple the base with the sidewall of the vehicle, wherein the clamp member is configured to be supported by the first and second guiding surfaces.

Embodiment 24 of the description—The vehicle rack system of embodiment 23, wherein the first guiding surface is opposite the second guiding surface.

Embodiment 25 of the description—The vehicle rack system of embodiment 23, wherein the wall includes an inner wall member adjacent to the sidewall of the vehicle, and wherein an elongated aperture is formed through the inner wall member such that the clamp member is configured to be adjustably moved within the elongated aperture.

Embodiment 26 of the description—The vehicle rack system of embodiment 23, further including a bolt extending through a slot formed in the top plate and into the interior space of the wall, and wherein the bolt couples with the clamp member.

Embodiment 27 of the description—The vehicle rack system of embodiment 23, wherein the clamp member is u-shaped and wherein the sidewall of the vehicle is clamped between the clamp member and the top plate.

Embodiment 28 of the description—The vehicle rack system of embodiment 23, wherein the clamp member is configured to couple with a rail of the vehicle.

Embodiment 29 of the description—The vehicle rack system of embodiment 23, wherein the clamp member includes a hook and an adjustable contact member slideably coupled to the hook and configured to reduce movement between the base and the sidewall of the vehicle.

Embodiment 30 of the description—The vehicle rack system of embodiment 29, wherein the adjustable contact member is biased towards the wall.

Embodiment 31 of the description—A vehicle rack system for a vehicle includes a first tower including a base configured to be removably coupled to the vehicle; an upright extending from the base; and an accessory upright coupled to the upright and the base, wherein the accessory upright is configured to couple with a plurality of rack system accessories.

Embodiment 32 of the description—The vehicle rack system of embodiment 31, wherein the accessory upright is disposed at an oblique angle relative to the upright.

Embodiment 33 of the description—The vehicle rack system of embodiment 31, wherein the accessory upright includes at least two coupling members along a length of the accessory upright.

Embodiment 34 of the description—The vehicle rack system of embodiment 33, wherein the at least two coupling member are disposed on a side of the accessory upright facing a bed of the vehicle.

Embodiment 35 of the description—The vehicle rack system of embodiment 31, further including a second tower spaced apart from the first tower, wherein the second tower includes an accessory upright, and at least one accessory of the plurality of rack system accessories couple with and extends from the accessory upright of the first tower to the accessory upright of the second tower.

Embodiment 36 of the description—The vehicle rack system of embodiment 35, wherein the plurality of rack system accessories includes a telescoping panel accessory, wherein the telescoping panel accessory includes a first panel slideably coupled to a second panel.

Embodiment 37 of the description—The vehicle rack system of embodiment 35, wherein the plurality of rack system accessories includes a telescoping rail accessory, wherein the telescoping rail accessory includes an inner rail slideably coupled to an outer rail.

Embodiment 38 of the description—The vehicle rack system of embodiment 37, further including an accessory plate coupled to the telescoping rail accessory.

Embodiment 39 of the description—The vehicle rack system of embodiment 38, wherein the accessory plate is coupled to the inner rail.

Embodiment 40 of the description—The vehicle rack system of embodiment 38, wherein the accessory plate includes an accessory slot.

Embodiment 41 of the description—The vehicle rack system of embodiment 40, wherein the accessory slot aligns with an outer rail slot extending through the outer rail.

Embodiment 42 of the description—The vehicle rack system of embodiment 31,wherein the upright, the accessory upright, and the base form a triangular structure.

Embodiment 43 of the description—An accessory rail for a vehicle rack system includes an outer rail; an inner rail slideably disposed in the outer rail; and an accessory plate coupled to a first side of the inner rail.

Embodiment 44 of the description—The accessory rail of embodiment 43, wherein the accessory plate is disposed only on the first side of the inner rail.

Embodiment 45 of the description—The accessory rail of embodiment 43, wherein the accessory plate includes an accessory slot.

Embodiment 46 of the description—The accessory rail of embodiment 45, wherein the accessory slot aligns with an outer rail slot extending along the outer rail.

Embodiment 47 of the description—The accessory rail of embodiment 43, wherein the inner rail includes a recess formed along a length of the inner rail, and wherein the accessory plate extends into the recess of the inner rail.

Embodiments of vehicle rack apparatuses, systems, and methods as discussed below can provide improved user operation for assembling a vehicle rack system, mounting a rack system to a vehicle, and adjusting a vehicle rack system to meet a user's needs or cargo requirements.

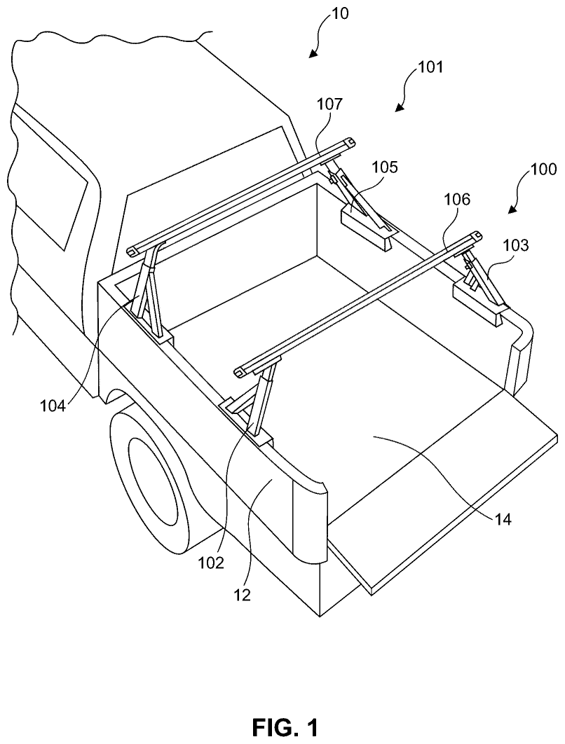

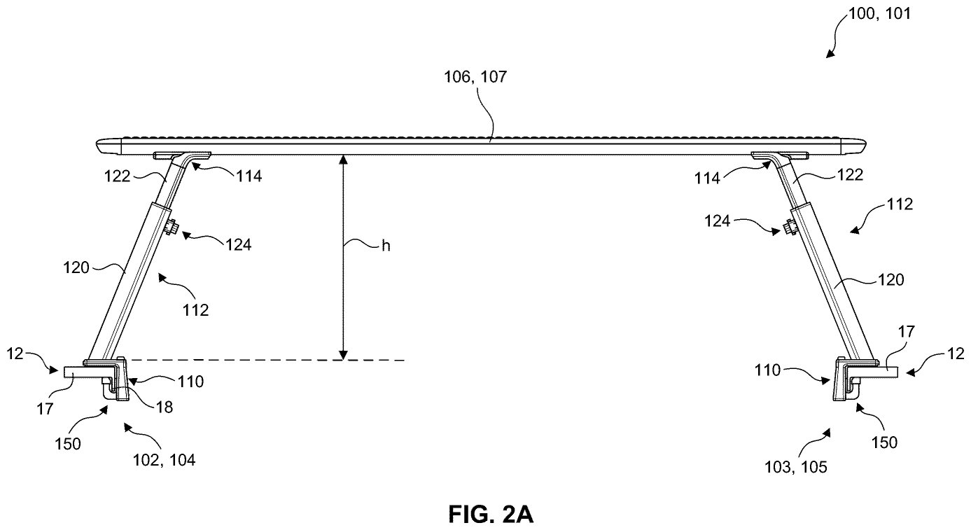

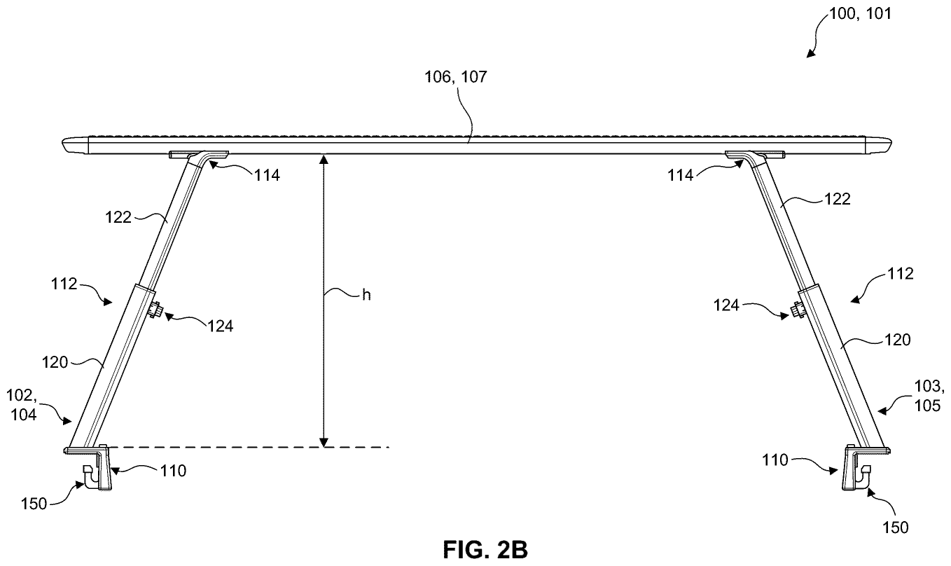

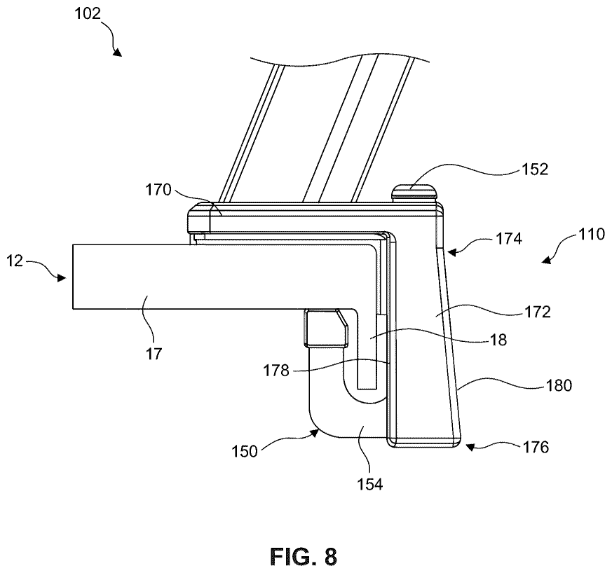

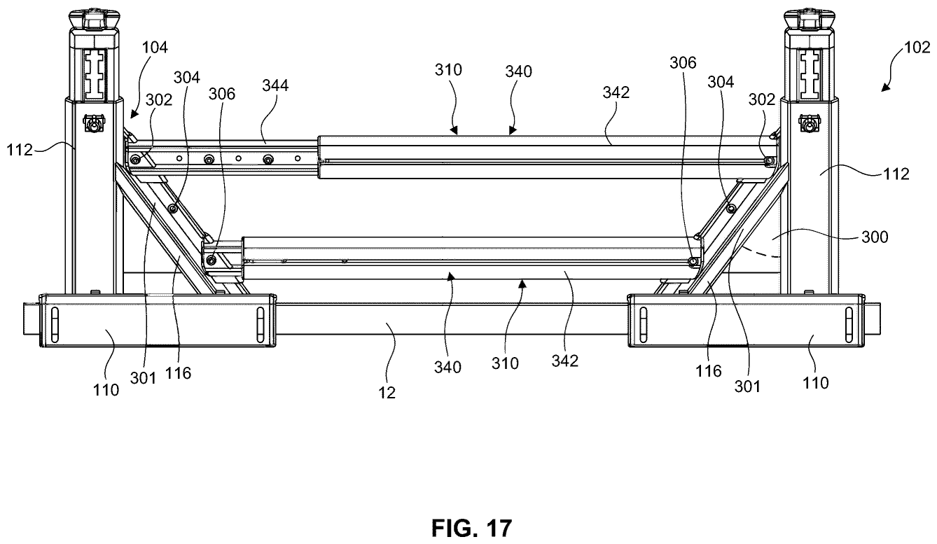

FIGS. 1-2B illustrate a vehicle rack system 100, according embodiments. Vehicle rack system 100 can be coupled to a vehicle 10 and configured to secure and carry a load or rack accessory. Vehicle rack system 100 can include a pair of towers 102, 103 that support a cross-rail 106 above the vehicle 10 and/or truck bed 14. Each tower 102, 103 can include an upright 112 with a locking system 124 that can extend and retract to adjust a height h of the cross-rail 106 relative to a base 110 of tower 102 and vehicle 10. In some embodiments, vehicle rack system 100 can couple to sidewalls 12 of a truck bed 14 of a pickup truck 10, for example, via a base 110 and a clamp member, for example a U-shaped clamp member 150 or a horizontal rail clamp member 160 as shown, for example, in FIGS. 8-16. In some embodiments, towers 102, 103 can include an accessory upright 116 coupled to and extending from upright 112 to base 110. Rack accessories 310, such as telescoping panels 320 and telescoping rails 340 can be coupled to and extend from accessory upright 116 to an adjacent accessory upright 116 of an adjacent tower 104, 105 mounted separately on vehicle 10 as shown, for example, in FIGS. 17-19 and 23.

In some embodiments, vehicle rack system 100 can couple to vehicle 10. In the illustrative embodiment shown in FIG. 1, vehicle rack system 100 can couple to sidewalls 12 of a truck bed 14 of vehicle 10. In some embodiments, vehicle rack system 100 can be configured to couple to other structures of a vehicle 10, such as, for example, vehicle roof rails. In some embodiments, more than one vehicle rack system can couple to vehicle 10. As shown, for example, in FIG. 1, a first vehicle rack system 100 can couple to a rearward portion of bed 14 and a second vehicle rack system 101 can couple to a forward portion of bed 14. In some embodiments, first vehicle rack system 100 can include a first tower 102, a second tower 103, and a cross-rail 106 coupled to and extending from first tower 102 to second tower 103. In some embodiments, a portion of cross-rail 106 can extend beyond a coupling location (e.g., a saddle) of first tower 102 and/or second tower 103. In some embodiments, second vehicle rack system 101 can include a third tower 104, a fourth tower 105, and a cross-rail 107 coupled to and extending from third tower 104 to fourth tower 105. In some embodiments, second vehicle rack system 101 can be the same or substantially similar to first vehicle rack system 100 and include the same or similar features as described below with respect to first vehicle rack system 100.

In some embodiments, first tower 102 can couple to a first side of bed 14 and second tower 103 can couple to a second side of bed 14 opposite the first side as shown, for example, in FIGS. 1 and 2A. Cross-rail 106 can couple to top ends of first and second towers 102, 103 such that cross-rail 106 is spaced apart from bed 14 and vehicle 10. In some embodiments, second tower 103 can be the same or substantially similar to first tower 102 and include the same or similar features of first tower 102 as described herein.

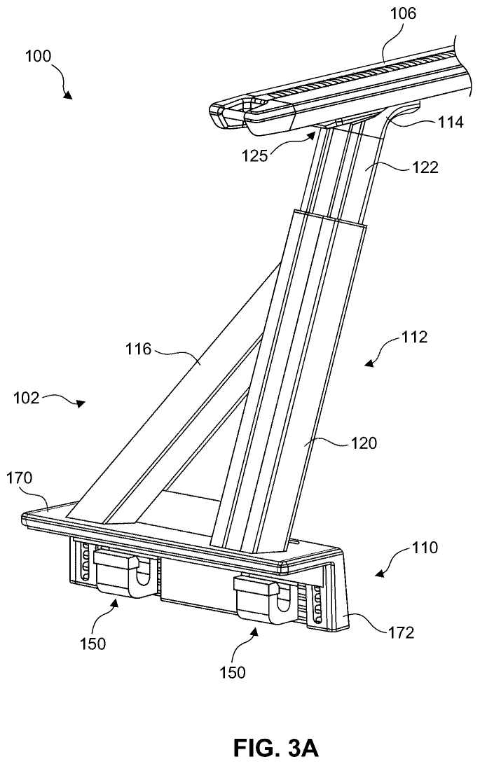

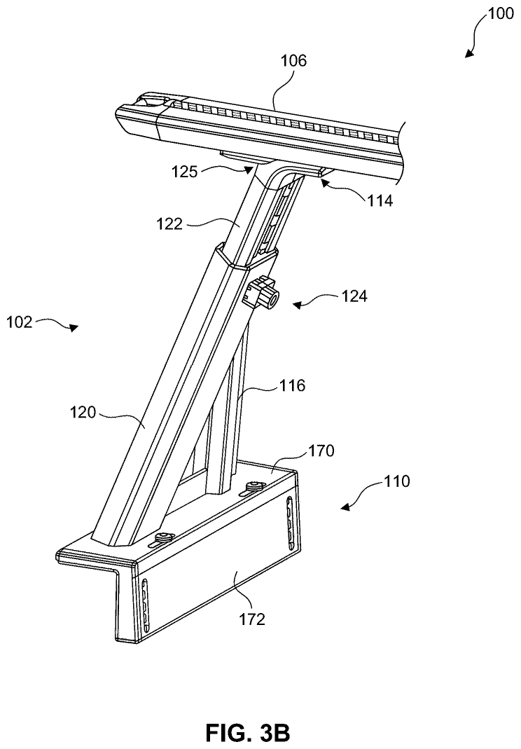

In some embodiments, first tower 102 can include a base 110, an upright 112, an upper saddle 114, and an accessory upright 116 as shown, for example, in FIGS. 3A and 3B. In some embodiments, base 110 can be removably coupled to sidewalls 12 to secure vehicle rack system 100 to vehicle 10. In some embodiments, upright 112 can be coupled to and extend away from base 110. In some embodiments, upright 112 can be configured to linearly extend and retract relative to base 110 to adjust a height h of cross-rail 106 relative to base 110. Upper saddle 114 can couple to a distal end 125 of upright 112 and be configured to adjustably couple with cross-rail 106. In some embodiments, accessory upright 116 can couple to and extend from base 110 to a first arm 120 of upright 112. In some embodiments, first arm 120 is stationary relative to base 110 and/or integrally formed with base 110. In the illustrative embodiments shown in FIGS. 3A and 3B, accessory upright 116 extends at an oblique angle 300 relative to upright 112. Accessory upright 116 can be configured to couple with one or more rack accessories 310. In some embodiments, the rack accessories can extend from the towers 102, 103 of the first vehicle rack system 100 to the towers 104, 105 of the second vehicle rack system 101.

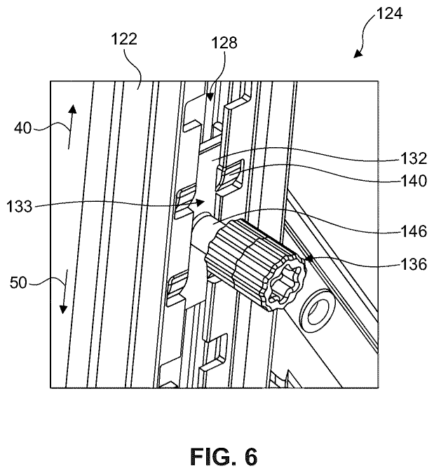

As illustratively shown in FIGS. 2A and 2B, upright 112 can extend (e.g., telescopically) to adjust height h of cross-rail 106 relative to base 110. In some embodiments, height h of cross-rail 106 relative to base 110 can be increased, as shown, for example, in FIG. 2B relative to FIG. 2A. In some embodiments, height h of cross-rail 106 relative to base 110 can be adjusted lower than shown, for example, in FIG. 2A. In some embodiments, upright 112 can include first arm 120, telescoping arm 122, and locking system 124 as shown, for example, in FIGS. 2A-7B. Upright 112 can extend away from base 110 approximately parallel to a lateral plane of vehicle 10 as shown, for example, in FIG. 17. Upright 112 can extend away from base 110 at an oblique angle relative to a longitudinal plane of vehicle 10 such that upright 112 extends towards the center of vehicle 10 and over bed 14 as it extends away from base 110, as shown, for example, in FIGS. 2A and 2B. In some embodiments, telescoping arm 122 can be slideably disposed in first arm 120. In some embodiments, as telescoping arm 122 slides relative to first arm 120 to increase height h of cross-rail 106 from base 110, adjacent upper saddles 114 of towers 102, 103 move closer to one another and further inboard (i.e., toward the center of vehicle 10) along cross-rail 106.

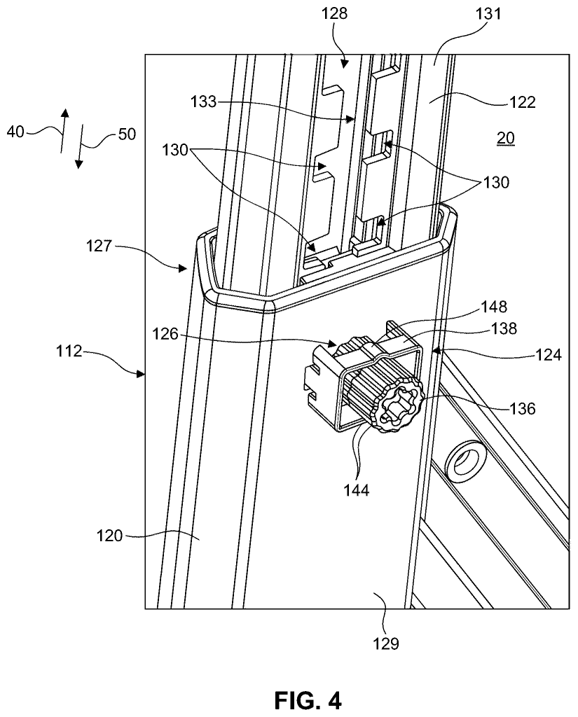

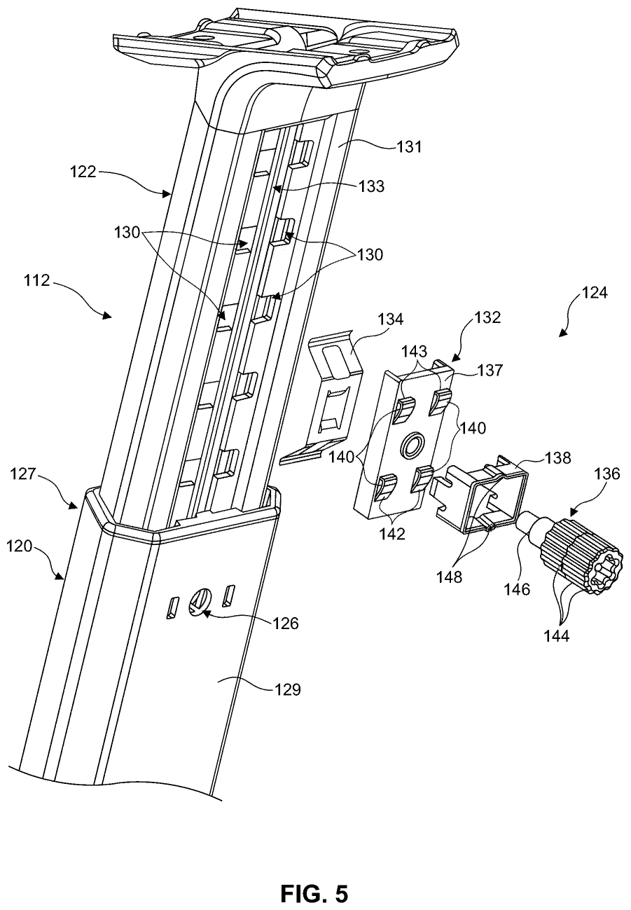

In some embodiments, first arm 120 can couple to and extend away from base 110. In some embodiments, telescoping arm 122 can be slideably disposed in first arm 120 and be configured to move relative to first arm 120. In some embodiments, telescoping arm 122 is configured to move away from and towards a distal end 127 of first arm 120. In some embodiments, as shown, for example in FIGS. 4-5, first arm 120 can include an aperture 126 formed through a side, for example, an inward facing side 129 of first arm 120. In some embodiments, aperture 126 can be configured to receive an actuator 136 of locking system 124 to fix locking system 124 relative to first arm 120. In some embodiments, aperture 126 is disposed at distal end 127 of first arm 120.

In some embodiments, telescoping arm 122 can include a slot 128, for example, formed along an interior length of telescoping arm 122 as shown, for example, in FIGS. 4-7B. Slot 128 can be configured to receive a lock plate 132 of locking system 124. In some embodiments, telescoping arm 122 can include a plurality of locking notches 130 and an actuator slot 133 that extends from an inward facing side 131 of telescoping arm 122 to slot 128. Plurality of locking notches 130 can be configured to releasably engage with lock plate 132. In the illustrative embodiment shown in FIGS. 4-6, pairs of locking notches 130 are arranged on opposite sides of actuator slot 133 and spaced apart along a length of inward facing side 131.

In some embodiments, locking system 124 is coupled to distal end 127 of first arm 120 and configured to releasably couple with telescoping arm 122 as shown, for example, in FIGS. 4-7B. In some embodiments, locking system 124 can move between a locked configuration 20 and a released configuration 30. For example, in the locked configuration 20, first arm 120 and telescoping arm 122 are fixed relative to one another. In the released configuration 30, telescoping arm 122 can slide in a first direction 40 relative to first arm 120, but telescoping arm 122 is temporarily fixed relative to first arm 120 in a second direction 50 opposite the first direction 40. In some embodiments, in the released configuration 30, telescoping arm 122 can be moved in the second direction 50 when actuator 136 is operated to disengage lock plate 132 from the plurality of locking notches 130.

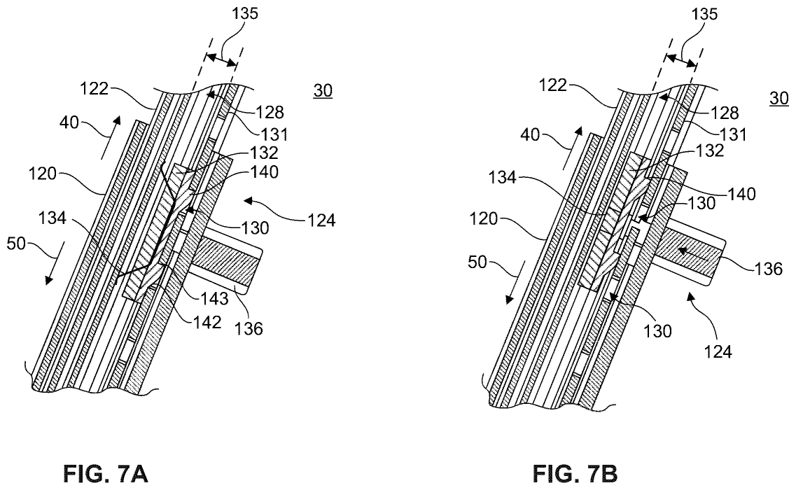

In some embodiments, locking system 124 can include lock plate 132, a spring 134, actuator 136, and/or a bracket 138 as shown, for example, in FIGS. 4-7B. Lock plate 132 and spring 134 can be received in slot 128 of telescoping arm 122. In some embodiments, lock plate 132 can include at least one protrusion 140 that extends away from a first surface 137 of lock plate 132 and releasably engages with the plurality of locking notches 130. In some embodiments, lock plate 132 can include two protrusions 140. In the illustrative embodiment shown in FIG. 5, lock plate 132 includes four protrusions 140. In some embodiments, spring 134 can be configured to bias lock plate 132 and protrusions 140 towards and into engagement with the plurality of locking notches 130. In some embodiments, slot 128 can be sized such that lock plate 132 can move across a depth 135 of slot 128 to engage and disengage with the plurality of locking notches 130 when locking system 124 is in released configuration 30, as shown, for example, in FIGS. 7A-7B. In some embodiments, protrusions 140 can include an angled face 142 such that when telescoping arm 122 is moved (e.g., pushed or pulled) in first direction 40, angled face 142 disengages protrusions 140 from the plurality of locking notches 130 to allow movement of telescoping arm 122 in first direction 40. In some embodiments, protrusions 140 can include an engagement face 143 approximately perpendicular with lock plate 132. Engagement face 143 can be configured to engage with the plurality of locking notches 130 to temporarily fix telescoping arm 122 in second direction 50 relative to first arm 120.

As illustratively shown in FIGS. 5-7B, actuator 136 couples with lock plate 132 and is configured to move locking system 124 from the locked configuration 20 to the released configuration 30. In some embodiments, actuator 136 can include a plurality of ribs 144 and a coupling portion 146. In some embodiments, plurality of ribs 144 is disposed on inward facing side 129 of first arm 120. Plurality of ribs 144 extends approximately parallel to an axis of actuator 136 and provides a user grip surface. Coupling portion 146 extends away from plurality of ribs 144 and through aperture 126 in first arm 120. Coupling portion 146 couples with lock plate 132 to fix locking system 124 relative to distal end 127 of first arm 120. In some embodiments, coupling portion 146 is disposed in actuator slot 133.

In some embodiments, coupling portion 146 can be threadably coupled to lock plate 132 such that when actuator 136 is rotated in a first rotated direction, for example clockwise, locking system 124 can be disposed in the locked configuration 20. For example, in the locked configuration 20, lock plate 132 is pulled towards and into engagement with the plurality of locking notches 130. In the locked configuration 20, actuator 136 holds and tightens lock plate 132 against the plurality of locking notches 130 and prevents movement of lock plate 132 across the depth 135 of slot 128 such that protrusions 140 remain engaged with the plurality of locking notches 130 in the locked configuration 20. As such, in the locked configuration 20, locking system 124 prevents movement of the telescoping arm 122 relative to the first arm 120.

When actuator 136 is rotated in a second rotated direction, opposite the first rotated direction, for example counterclockwise, locking system 124 can be disposed in the released configuration 30. For example, in the released configuration 30, lock plate 132 is loosened relative to telescoping arm 122 and the plurality of locking notches 130 such that lock plate 132 can move across the depth 135 of slot 128. In some embodiments, spring 134 continues to bias lock plate 132 into temporary engagement with the plurality of locking notches 130 in the released configuration 30. In the released configuration 30, when telescoping arm 122 is moved in first direction 40, angled face 142 of protrusions 140 urges lock plate 132 away from the plurality of locking notches 130 such that protrusions 140 disengage the plurality of locking notches 130, allowing telescoping arm 122 to move in first direction 40. Spring 134 can bias lock plate 132 and protrusions 140 into the engagement with the plurality of locking notches 130, such that when movement of the telescoping arm 122 in the first direction 40 stops, it temporarily fixes first arm 120 and telescoping arm 122 in position. In some embodiments, in the released configuration, actuator 136 can be operated to urge lock plate 132 away from the plurality of locking notches 130. When actuator 136 moves lock plate 132, protrusions 140 disengage from the plurality of locking notches 130, such that telescoping arm 122 can be moved in second direction 50. In some embodiments, when actuator 136 is released, spring 134 can bias lock plate 132 towards the plurality of locking notches such that protrusions 140 engage the plurality of locking notches 130 to temporarily fix first arm 120 and telescoping arm 122 in position. In some embodiments, actuator 136 can be rotated to move locking system 124 from the locked configuration 20 to the released configuration 30. In some embodiments, actuator 136 can be linearly moved in the released configuration 30 to disengage protrusions 140 from the plurality of locking notches 130 to allow movement of the telescoping arm 122 in the second direction 50.

In some embodiments, bracket 138 can couple to first arm 120 as shown, for example, in FIGS. 4 and 5. In some embodiments, bracket 138 can be configured to resist rotational movement of actuator 136 and allow translation movement of actuator 136. In the illustrative embodiment shown in FIG. 4, bracket 138 couples to first arm 120 adjacent to aperture 126. Bracket 138 can extend around actuator 136 and include recesses 148 that releasably engage with plurality of ribs 144. In some embodiments, when a user rotates actuator 136, adjacent ribs of the plurality of ribs 144 disengage from and then engage with recess 148. In some embodiments, a user can provide additional rotational force to actuator 136 to disengage a rib 144 from recesses 148. When vehicle rack system 100 is in use, bracket 138 provides anti-rotation function to prevent actuator 136 from rotating and moving to the released configuration 30 from the locked configuration 20. In some embodiments, bracket 138 guides translation movement of actuator 136 when locking system 124 is in the released configuration 30 and actuator 136 is actuated to move telescoping arm 122 in the second direction 50.

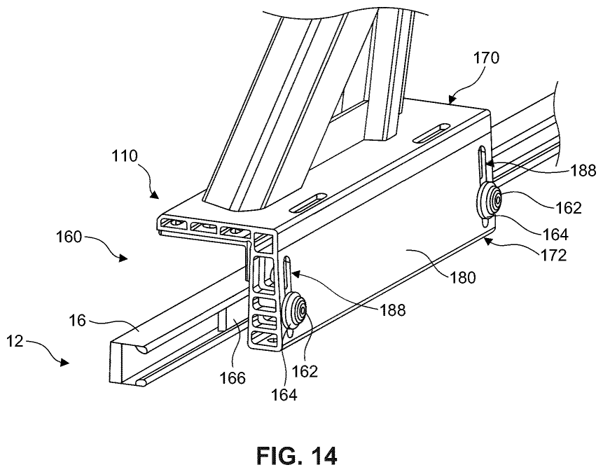

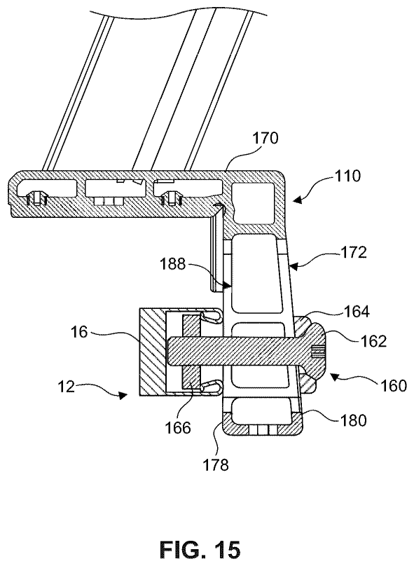

In some embodiments, base 110 can be configured to couple with sidewalls 12 of vehicle 10. In some embodiments, base 110 can be configured to couple to sidewall 12 of vehicle 10 with different styles of clamp 150, 160. For example, in some embodiments, base 110 can be configured to couple to sidewall 12 with a U-shaped clamp member 150 as shown, for example, in FIGS. 8-13. In some embodiments, base 110 can be configured to couple to a rail 16 mounted on sidewall 12 of vehicle 10 with a horizontal rail clamp member 160 as shown, for example, in FIGS. 14 and 15.

In some embodiments, base 110 can include top plate 170 and wall 172 as shown, for example, in FIGS. 8, 9, and 12-16. In some embodiments, top plate 170 can be mounted on top of sidewall 12. In some embodiments, top plate 170 can be approximately parallel to top panel 17 of sidewall 12. Wall 172 can extend away from top plate 170 and toward bed 14. In some embodiments, wall 172 can extend approximately adjacent to sidewall 12. In some embodiments, wall 172 can extend approximately perpendicular to top plate 170. In some embodiments, wall 172 can include a proximal end 174 adjacent to top plate 170, a distal end 176, a first wall 178, and a second wall 180. In some embodiments, wall 172 can extend from proximal end 174 to distal end 176 by a distance between about 2 inches and about 8 inches. In some embodiments, wall 172 can extend from proximal end 174 to distal end 176 by a distance between about 3 inches and about 6 inches. In some embodiments, wall 172 can extend from proximal end 174 to distal end 176 by a distance of about 4 inches. First wall 178 can extend from proximal end 174 to distal end 176 adjacent to sidewall 12. In some embodiments, first wall 178 can be an inner wall 178 and face sidewall 12. In some embodiments, first wall 178 can be approximately parallel to sidewall 12.

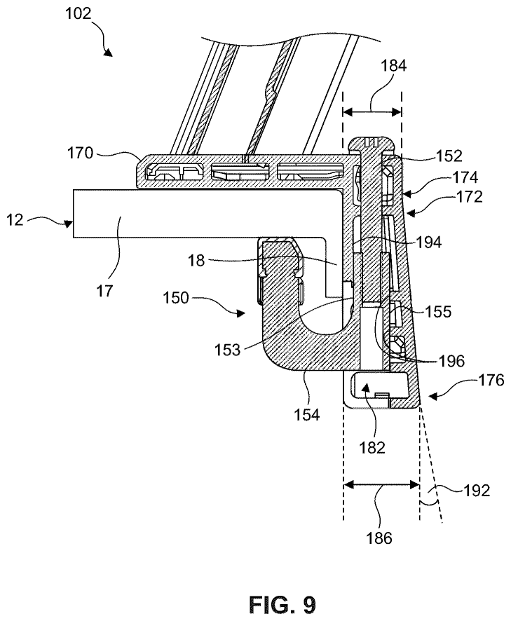

In some embodiments, second wall 180 can extend from proximal end 174 to distal end 176 and be spaced apart from first wall 178 to form an exterior bed-facing wall 180 of wall 172. In some embodiments, second wall 180 can extend at an oblique angle 192 relative to first wall 178 to form a wedge wall 172. In some embodiments, angle 192 can be between about 1 degree to about 20 degrees relative to first wall 178. In some embodiments, angle 192 can be between about 5 degrees to about 10 degrees relative to first wall 178. In some embodiments, second wall 180 can extend parallel to first wall 178. In some embodiments, wall 172 can have a first thickness 184 at proximal end 174 between first wall 178 and second wall 180. In some embodiments, wall 172 can have a second thickness 186 at distal end 176 between first wall 178 and second wall 180. In some embodiments, second thickness can be greater than first thickness, as shown, for example, in FIGS. 8 and 9. In some embodiments, first thickness can be greater than second thickness. In some embodiments, the wedge shape of wall 172 prevents base 110 from lifting away from sidewall 12 because horizontal clamp member 160 can tighten when wall 172 lifts due to the increasing thickness towards distal end 176 of wall 172. In some embodiments, when horizontal clamp member 160 is tightened against rail 16, the wedge shape of wall 172 pulls base 110 towards sidewall 12 to provide a closer coupling between sidewall 12 and base 110.

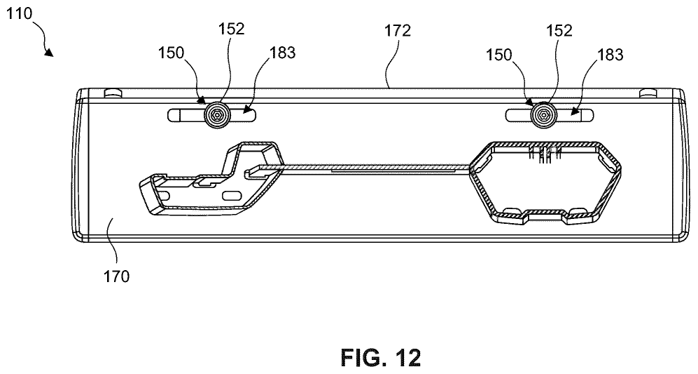

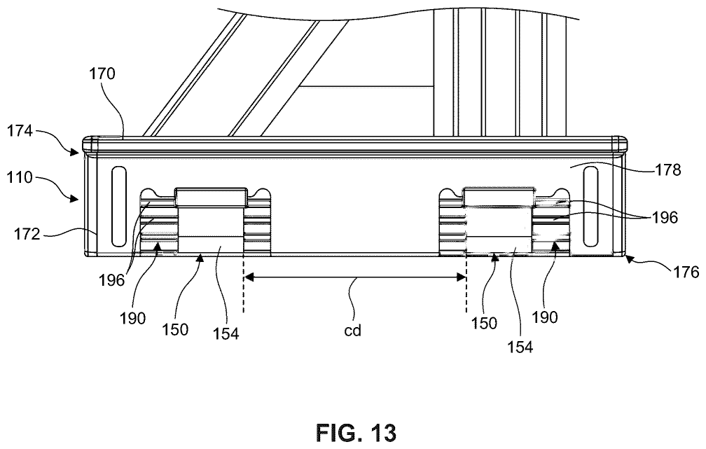

In some embodiments, an interior space 182 is formed between first wall 178 and second wall 180 as shown, for example, in FIG. 9. In some embodiments, first wall 178 can include a first guiding surface 194 that faces interior space 182. In some embodiments, second wall 180 can include a second guiding surface 196 opposite first guiding surface 194 and facing interior space 182. In some embodiments, second guiding surface 196 can include a plurality of co-planar ribs. In some embodiments, first guiding surface 194 and second guiding surface 196 can be configured to support movement of U-shaped clamp member 150 when U-shaped clamp member 150 couples with sidewall 12. In some embodiments, a slot 183 is formed through top plate 170 and extends into interior space 182 at proximal end 174 of wall 172 as shown, for example, in FIGS. 9 and 12. In some embodiments, an elongated aperture 190 is formed through first wall 178 and extends into interior space 182 as shown, for example, in FIG. 13. In some embodiments, elongated aperture 190 is formed in distal end 176 of first wall 178 and extends approximately midway between proximal end 174 and distal end 176 along first wall 178.

In some embodiments, U-shaped clamp member 150 can couple base 110 to sidewall 12 as shown, for example, in FIGS. 2A, 8, and 9. In some embodiments, U-shaped clamp member 150 can include bolt 152 and U-shaped hook 154. In some embodiments, bolt 152 can translate hook 154 relative to top plate 170 such that sidewall 12 can be coupled between top plate 170 and hook 154 of U-shaped clamp member 150. In some embodiments, bolt 152 can extend through slot 183 in top plate 170 and into interior space 182. In some embodiments, bolt 152 can couple to U-shaped hook 154 within interior space 182. In some embodiments, a portion of hook 154 can be disposed in interior space 182 and a portion of hook 154 can extend out of elongated aperture 190 and away from base 110. In some embodiments, hook 154 can include first surface 153 and second surface 155. In some embodiments, first surface 153 of hook 154 can contact first guiding surface 194 of first wall 178 and second surface 155 of hook 154 can contact second guiding surface 196 of second wall 180. In some embodiments, guiding surfaces 194, 196 can support hook 154 and maintain alignment with bolt 152 to reduce bending of bolt 152 when clamp force is applied to u-shaped clamp member 150.

In some embodiments, vehicle rack system 100 can include two U-shaped clamp members 150 to couple base 110 to sidewall 12 as shown, for example, in FIGS. 3A, 3B, 12, and 13. Vehicle 10 can include additional features and protrusions in sidewalls 12 that can obstruct clamp members 150 in an initial position in slots 183 and elongated aperture 190. In some embodiments, slots 183 in top plate 170 and elongated apertures 190 in first wall 178 can be configured to provide flexible mounting positioning for U-shaped clamp member 150 along the length of sidewall 12 to avoid contacting any obstructions in sidewall 12. Slots 183 and elongated apertures 190 allow for lateral movement of clamp members 150 to adjust a clamp distance cd between adjacent clamp members 150 to avoid obstructions of sidewall 12.

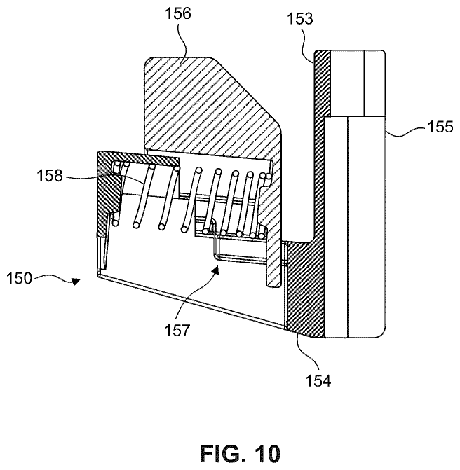

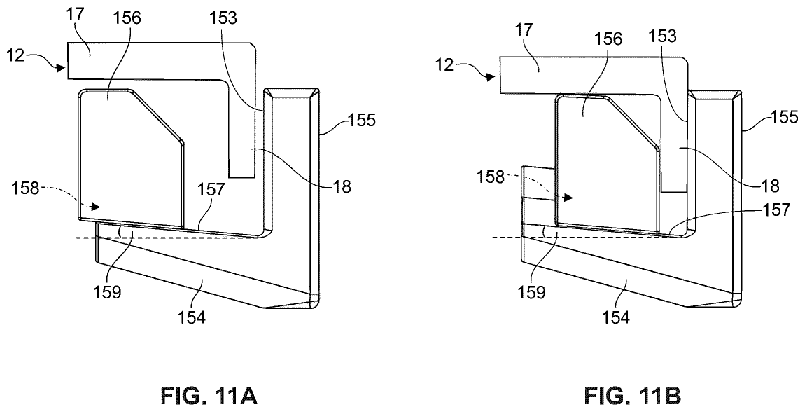

In some embodiments, hook 154 of U-shaped clamp member 150 can include an adjustable clamp member 156 and a spring 158 as shown, for example, in FIGS. 10-11B. In some embodiments, spring 158 can bias adjustable clamp member 156 towards first wall 178 of base 110. In some embodiments, sidewall 12 can include a top panel 17 and a ledge 18 extending away from top panel 17 toward bed 14. In some embodiments, adjustable clamp member 156 can be biased towards ledge 18 to form a close fit with ledge 18 of sidewall 12. In some embodiments, adjustable clamp member 156 can be slideably coupled to hook 154 along a base 157 of hook 154. In some embodiments, adjustable clamp member 156 can slide at an oblique angle 159 along a base 157 relative to top plate 170. In some embodiment, when adjustable clamp member 156 contacts top panel 17 of sidewall 12 during clamping, a downward force exerted on adjustable clamp member 156 causes adjustable clamp member 156 to be urged towards ledge 18 by angled base 157 to further secure U-shaped clamp member 150 to ledge 18 of sidewall 12. In some embodiments, the downward force on adjustable clamp member 156 reacts off the angled base 157 to create a lateral force of the adjustable clamp member 156 towards ledge 18. In some embodiments, when adjustable clamp member 156 contacts ledge 18, the lateral force clamps ledge 18 between adjustable clamp member 156 and wall 172.

In some embodiments, base 110 can be coupled to a rail 16 of sidewall 12 with horizontal clamp member 160 as shown, for example, in FIGS. 14 and 15. In some embodiments, horizontal clamp member 160 can include bolt 162, domed washer 164, and/or coupling plate 166. In some embodiments, coupling plate 166 can be disposed in a slot formed in rail 16. In some embodiments, a vertical slot 188 can be formed through wall 172, and bolt 162 can extend from second wall 180, through wall 172, and couple with coupling plate 166. In some embodiments, domed washer 164 can accommodate oblique angle 192 of second wall 180, such that bolt 162 can couple perpendicularly with coupling plate 166. In some embodiments, vertical slot 188 can be configured to provide flexible mounting positioning for horizontal clamp member 160 to accommodate different rail 16 positioning relative to top panel 17 of sidewall 12 in different vehicles. In some embodiments, the wedge shape of wall 172 prevents base 110 from lifting away from sidewall 12 because horizontal clamp member 160 can tighten when wall 172 lifts due to the increasing thickness towards distal end 176 of wall 172. In some embodiments, when horizontal clamp member 160 is tightened against rail 16, the wedge shape of wall 172 pulls base 110 towards sidewall 12 to provide a closer coupling between sidewall 12 and base 110.

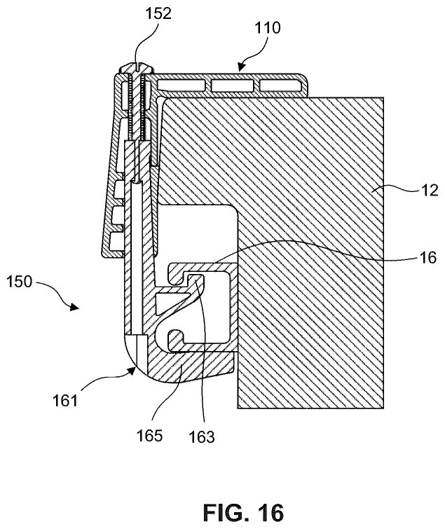

In some embodiments, hook member 161 can be configured to couple with rail 16 as shown, for example, in FIG. 16. In some embodiments, hook member 161 can couple with bolt 152 of clamp member 150. In some embodiments, hook member 161 can include a first hook 163 and second hook 165. In some embodiments, first hook 163 can extend into and couple with an upper portion of rail 16. In some embodiments, second hook 165 can extend below rail 16 and contact a lower surface of rail 16. In some embodiments, hook member 161 can be rotated into connection with rail 16 such that first hook 163 inserts into rail 16 and then second hook 165 contacts lower surface of rail 16 as hook member 161 is rotated into position.

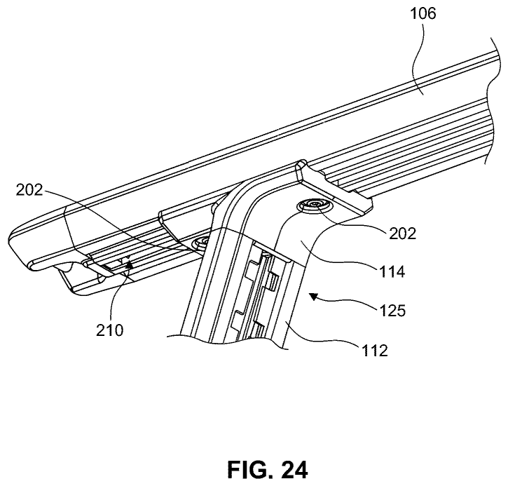

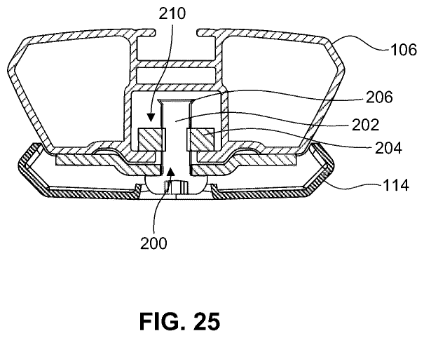

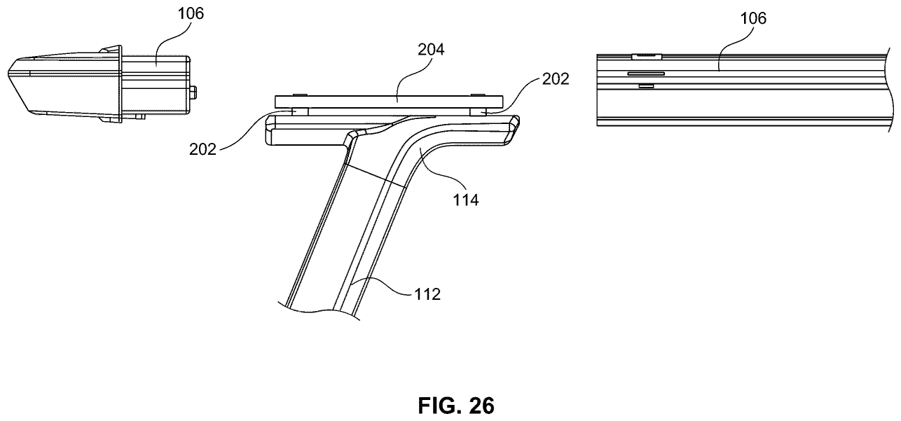

In some embodiments upper saddle 114 can slideably couple with cross-rail 106 as shown, for example, in FIGS. 24-26. In some embodiments, upper saddle 114 can include apertures 200, bolts 202 (or other fasteners), and/or rail plate 204. In some embodiments, rail plate 204 is disposed above upper saddle 114. In some embodiments, bolts 202 extend through apertures 200 and couple with rail plate 204. In some embodiments, upper saddle 114 includes at least two bolts 202. In some embodiments, rail plate 204 can be pre-assembled to upper saddle 114. In some embodiments, bolt 202 can include bolt stop 206 extending radially outward from a distal end of bolt 202. In some embodiments, bolt stop 206 can prevent bolt 202 from decoupling with rail plate 204. In some embodiments, bolts 202 are not detachable from rail plate 204. In some embodiments, slot 210 is formed in cross-rail 106 along the length of cross-rail 106. In some embodiments, rail plate 204 is disposed in slot 210 to couple upper saddle 114 to cross-rail 106. In some embodiments, before a height h of cross-rail 106 is adjusted by extending uprights 112, bolts 202 can be loosened such that upper saddle 114 can slide relative to cross-rail 106. As shown, for example, in FIGS. 2A and 2B, as height h is increased relative to base 110, adjacent upper saddles 114 of first and second towers 102, 103 move closer together. In some embodiments, when a desired height h of cross-rail 106 is reached, bolts 202 can be tightened to secure cross-rail 106 in position relative to upper saddles 114. In some embodiments, a quick release lever and shaft can be coupled to rail plate 204 and be configured to tighten and loosen rail plate 204 in cross-rail 106 slot 210 to releasably couple cross-rail 106 and upper saddle 114.

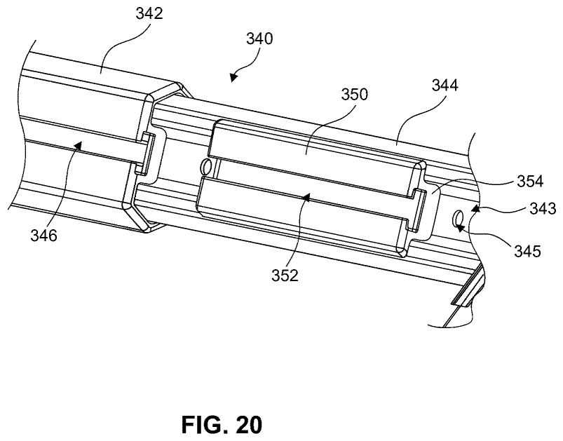

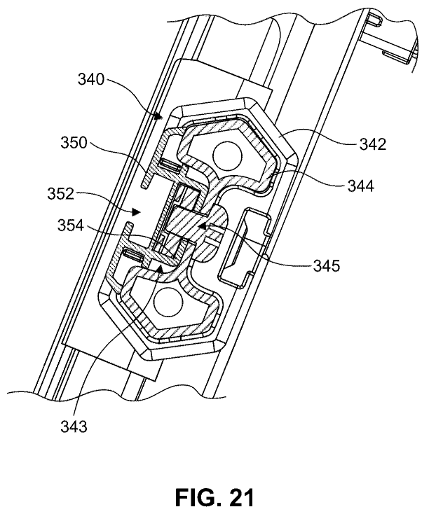

In some embodiments, accessory upright 116 can be configured to couple with one or more rack accessories 310, as shown, for example, in FIGS. 17-23. In some embodiments, accessory upright 116 can couple to and extend from base 110 to first arm 120 of upright 112. In some embodiments, accessory upright 116 can be integral with base 110 and first arm 120 of upright 112. In some embodiments, accessory upright 116 can extend at an oblique angle 300 relative to upright 112. In some embodiments, oblique angle 300 can be between about 15 degrees and about 75 degrees relative to upright 112. In some embodiments, oblique angle 300 can be between about 30 degrees and about 60 degrees relative to upright 112. In some embodiments, oblique angle 300 can be about 45 degrees relative to upright 112. In some embodiments, accessory upright 116 can include one or more coupling members 302, 304, 306 spaced apart along accessory upright 116. In some embodiments, the coupling members 302, 304, 306 are disposed on an inward bed-facing side 301 of accessory upright 116. In some embodiments, the plurality of coupling members 302, 304, 306 are equally spaced along accessory upright 116. In the illustrative embodiment shown in FIG. 17, accessory upright 116 can include three coupling members 302, 304, 306. In some embodiments, accessory upright 116 can include more or less than three coupling members. In some embodiments, coupling members 302, 304, 306 can be recess threads formed in accessory upright 116. In some embodiments, coupling members 302, 304, 306 can be integrated threaded nuts disposed on accessory upright 116. In some embodiments, coupling members 302, 304, 306 can be apertures formed through accessory upright 116 that bolts or similar attaching components can extend through to couple accessories 310 to accessory upright 116. In some embodiments, coupling members 302, 304, 306 can be hooks, eyehooks, loops, or other similar fastening members disposed on accessory upright 116.

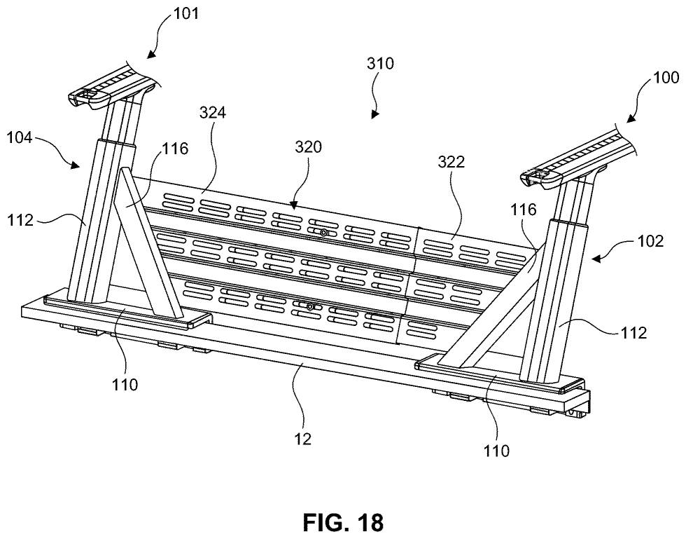

Rack accessories 310, such as telescoping panels 320 and telescoping rails 340 can be coupled to and extend from accessory upright 116 of first or second tower 102, 103 to an accessory upright 116 of adjacent third or fourth tower 104, 105 as shown, for example, in FIGS. 17-19 and 23. In some embodiments, the rack accessories 310 can include telescoping panels 320 as shown, for example, in FIG. 18. In some embodiments, telescoping panels 320 can include first panel 322 and second panel 324. In the illustrative embodiment shown in FIG. 18, first panel 322 can couple to accessory upright 116 of first tower 102, second panel 324 can couple to accessory upright 116 of third tower 104, and first and second panels 322, 324 can be coupled to one another. In some embodiments, first and second panels 322, 324 can couple to at least one coupling member 302, 304, 306 of accessory uprights 116.

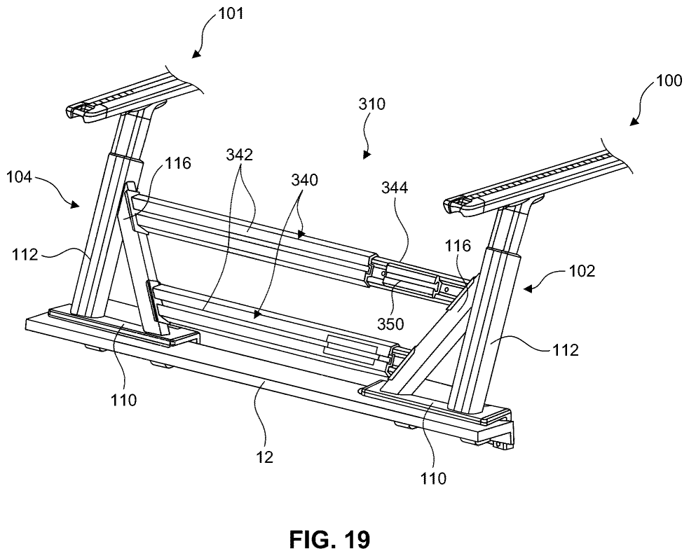

In some embodiments, the plurality of rack accessories 310 can include telescoping rails 340 as shown, for example, in FIGS. 17, and 19-21. In some embodiments, telescoping rails 340 can include outer rail 342, inner rail 344, and/or accessory plate 350. In the illustrative embodiment shown in FIG. 19, two telescoping rails 340 can be coupled between adjacent towers 102, 103, 104, 105. In some embodiments, more or less than two telescoping rails 340 can be coupled to adjacent towers 102, 103, 104, 105. In some embodiments, outer rail 342 can couple to accessory upright 116 of first tower 102, inner rail 344 can couple to accessory upright 116 of third tower 104, and inner rail 344 can be slideably disposed within outer rail 342. In some embodiments, telescoping rail 340 can couple to any one of coupling member 302, 304, 306 of accessory uprights 116.

In some embodiments, accessory plate 350 can couple to inner rail 344 as shown, for example, in FIGS. 19-21. In some embodiments, outer rail 342 can include accessory slot 346 to provide a fixture to attach and couple equipment (e.g., sports equipment such as a bicycle rack) or other accessories to outer rail 342. In some embodiments, inner rail 344 does not include a slot. In some embodiments, accessory plate 350 can include an accessory slot 352. In some embodiments, accessory plate 350 can couple to inner rail 344 such that accessory slot 352 of accessory plate 350 can provide a fixture to attach and couple equipment or other accessories to inner rail 344. In some embodiments, when accessory plate 350 is coupled to inner rail 344, accessory slots 346, 352 can be aligned. In some embodiments, inner rail 344 can include an elongated recess 343 and a plurality of apertures 345 formed in recess 343. In some embodiments, accessory plate 350 can include a flange 354 that extends into recess 343 of inner rail 344. In some embodiments, flange 354 can be opposite accessory slot 352. In some embodiments, accessory plate 350 can be coupled to inner rail 344 in a plurality of positions via the plurality of aperture 345. In some embodiments, accessory plate 350 is only disposed on a single side of inner rail 344.

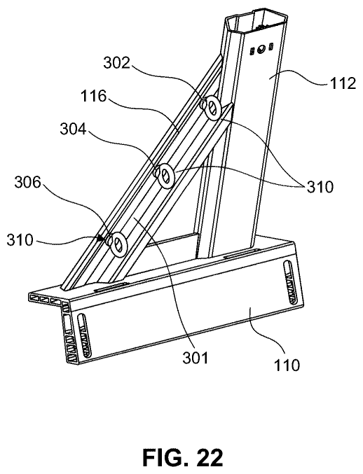

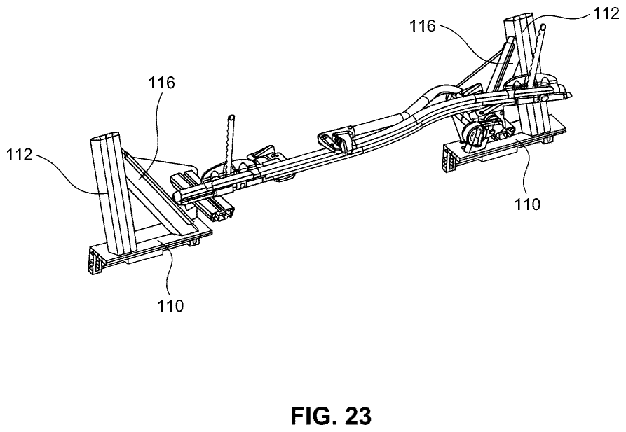

In some embodiments, the plurality of rack accessories 310 can include fish-eye hooks that attach to coupling members 302, 304, 306 as shown, for example, in FIG. 22. In some embodiments, the plurality of rack accessories 310 can include a bicycle rack or a portion thereof to couple a bicycle (not shown) to the vehicle rack system 100, as shown, for example, in FIG. 23.

It is to be appreciated that the Detailed Description section, and not the Brief Summary and Abstract sections, is intended to be used to interpret the claims. The Summary and Abstract sections may set forth one or more but not all embodiments of the vehicle rack system and apparatus, and thus, are not intended to limit the present embodiments and the appended claims.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A vehicle rack system for adjustably attaching equipment to a vehicle, the vehicle rack system comprising:
a base configured to be removably coupled to the vehicle;
an upper saddle spaced apart from the base and coupled to a cross-rail; and
a telescoping upright extending from the base to the upper saddle, wherein the telescoping upright comprises:
a first arm,
a telescoping arm slideably disposed within the first arm, and
a locking system configured to releasably couple the first arm and the telescoping arm,
wherein when the locking system is actuated, the telescoping arm slides relative to the first arm to adjust a distance between the cross-rail and the base.

2. The vehicle rack system of claim 1, wherein the telescoping arm comprises a slot and a plurality of locking notches, and wherein the locking system comprises a lock plate disposed within the slot and configured to releasably engage the plurality of locking notches to lock the telescoping arm relative to the first arm.

3. The vehicle rack system of claim 2, wherein the lock plate comprises at least two protrusions configured to engage at least two notches of the plurality of locking notches.

4. The vehicle rack system of claim 2, wherein the lock plate is biased towards the plurality of locking notches.

5. The vehicle rack system of claim 2, wherein the locking system further comprises an actuator adjustably coupled to the lock plate and extending through an aperture in the first arm, wherein the actuator is configured to adjust the locking system between a locked configuration and a released configuration.

6. The vehicle rack system of claim 5, wherein in the locked configuration, the actuator holds the lock plate in engagement with the plurality of locking notches such that the telescoping arm is fixed relative to the first arm.

7. The vehicle rack system of claim 5, wherein in the released configuration, the lock plate is displaced within in the slot such that when the telescoping arm is moved in a first direction relative to the first arm, the lock plate disengages from the plurality of locking notches, and when the telescoping arm is moved in a second direction opposite the first direction, the lock plate engages the plurality of locking notches to fix the telescoping arm relative to the first arm.

8. The vehicle rack system of claim 5, further comprising a bracket coupled to the first arm and extending around the actuator, wherein the bracket is configured to reduce rotation of the actuator and allow translation of the actuator.

9. A method of adjusting a height of a vehicle rack system, wherein the vehicle rack system comprises a base, an upright, and a cross-rail spaced apart from the base by the upright, the method comprising:
actuating a locking system of the upright to move the locking system from a locked configuration to a released configuration; and
moving a telescoping arm of the upright relative to a first arm of the upright in a first direction to adjust the height of the cross-rail relative to the base,
wherein the locking system is configured to temporarily prevent movement of the upright in a second direction opposite the first direction when the locking system is in the released configuration.

10. The method of claim 9, wherein actuating the locking system comprises rotating an actuator of the locking system in a first revolving direction.

11. The method of claim 9, wherein moving the upright comprises sliding the telescoping arm relative to the first arm.

12. The method of claim 11, wherein the telescoping arm is coupled to the cross-rail and the first arm is coupled to the base.

13. The method of claim 11, wherein the locking system is coupled to the first arm and releasably coupled to the telescoping arm.

14. The method of claim 10, further comprising:
further actuating the locking system to disengage a lock plate of the locking system from the telescoping arm; and
moving the telescoping arm in the second direction to adjust the height of the cross-rail relative to the base.

15. The method of claim 14, wherein further actuating the locking system comprises translating an actuator of the locking system relative to the upright to disengage the lock plate from at least one locking notch of a plurality of locking notches formed in the telescoping arm.

16. The method of claim 15, further comprising:
setting a height of the cross-rail relative to the base by moving the telescoping arm in one of the first direction or the second direction; and
rotating the actuator in a second revolving direction opposite the first revolving direction to move the locking system from the released configuration to the locked configuration to fix the telescoping arm relative to the first arm.

17.-47. (canceled)
